(19) United States
(12) Patent Application Publication
(10) Pub. No.: US 2026/0105388 A1
(43) Pub. Date: Apr. 16, 2026

(54) ADIABATIC QUANTUM ALGORITHM FOR ELECTRIC VEHICLE CHARGING STATION SELECTION

(71) Applicant: BP Corporation North America Inc., Houston, TX (US)

(72) Inventors: Shangjie Guo, Greenbelt, MD (US); Claudia Perry, London (GB); Clena Marie Abuan, Houston, TX (US); Jonathan Rudolph Wurtz, Burlington, MA (US)

(73) Assignee: BP Corporation North America Inc., Houston, TX (US)

(21) Appl. No.: 19/352,733

(22) Filed: Oct. 8, 2025

Related U.S. Application Data
(60) Provisional application No. 63/705,595, filed on Oct. 10, 2024.

(51) Int. Cl. G06Q 10/047; G06N 10/60

(52) U.S. Cl. CPC G06Q 10/047; G06N 10/60

(57) ABSTRACT

A technique for solving an optimization problem comprises obtaining, by a classical computing component, initial parameters to an optimization problem stored in memory of the classical computing component; creating, by the classical computing component, an objective function to the optimization problem based on the initial parameters; computing, by the classical computing component, based on the objective function and the initial parameters, encoded data to apply to a plurality of qubits in a quantum computing component; applying, by a quantum computing component, the encoded data to an initial state of the plurality of qubits to produce an updated state; providing, by the quantum computing component, raw measurements of the updated state to the classical computing component; and implementing, by the classical computing component, a post-selection procedure to the optimization problem using the initial parameters and the raw measurements to obtain an optimized solution to the optimization problem.

### CROSS-REFERENCE TO RELATED APPLICATIONS

This application is non-provisional patent application of U.S. provisional patent application Ser. No. 63/705,595, filed Oct. 10, 2024, and entitled “Adiabatic Quantum Algorithm for Electric Vehicle Charging Station Selection,” which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to an adiabatic quantum algorithm that is implemented on hybrid classical-quantum computer systems for optimizing selection of electric vehicle (EV) charging stations.

Optimization problems are prevalent in numerous areas of science and engineering, ranging from finance to physics, and from computer science to economics. Although straightforward optimization problems can be solved by finding the optimal solution that maximizes or minimizes a given objective function, real-world situations often involve more complex constraints, such as physical or operational limitations, budget constraints, or legal requirements. In such cases, constrained optimization techniques are required to find the optimal solution that satisfies all the constraints. One such application of an optimization problem is in the field of EV charging stations. Accordingly, optimization tools have been applied to solve complex energy systems problems.

The use of EV in transportation and other forms of clean energy in industry has been growing on an annual basis with a goal of environmental protection as more of the world population has shifted away from purchasing vehicles with internal combustion engines to electric vehicles. The rising demand for EVs has put added pressure on EV infrastructure providers to provide more EV charging stations and other EV infrastructure. As a result, EV infrastructure providers have shown an interest in deploying additional EV charging stations by increasing their efforts in the design, control, and planning of EV charging stations. EV charging stations may likely be found in high-density areas that are easily accessible to the population such as, for example, in shopping centers, gas stations, hospitals, hotels, or other similar types of buildings. Further, providing a suitable location for an EV charging station is a complex spatial combinatorial optimization problem that is vital to supporting a growing EV-based population. For instance, identifying a suitable location for an EV charging station in a geographical area has to consider benefits to EV owners while also considering geographical and operational constraints in order to maximize revenues to the EV infrastructure provider. The investment costs in building an EV charging station are large. Identifying suitable sites/locations for EV charging stations requires optimizing an objective function that maximizes profits (or return on investment) for the EV station provider, while at the same time enabling EV owners to access more EV charging stations. Optimal sites/locations of EV charging stations are vital to support a growing EV infrastructure and, if an EV charging station is not located in a geographical area that attracts EV owners and maximizes revenues for an EV infrastructure provider, the investment costs to the EV infrastructure provider in building the EV charging station may not be justified.

### SUMMARY

In an example of the present disclosure, a method for optimizing selection of EV charging stations is provided. The method includes obtaining, by a classical computing component, initial parameters to an optimization problem stored in memory of the classical computing component; creating, by the classical computing component and based on the initial parameters, an objective function to the optimization problem based on the initial parameters; computing, by the classical computing component and based on the objective function and the initial parameters, encoded data; applying, by a quantum computing component, the encoded data to an initial state of the plurality of qubits to produce an updated state of the plurality of qubits; providing, by the quantum computing component, raw measurements of the updated state to the classical computing component; and implementing, by the classical computing component and based on the initial parameters and the raw measurements, a post-selection procedure to the optimization problem to obtain an optimized solution to the optimization problem.

In another example of the present disclosure, a hybrid quantum-classical computer is provided that includes a classical computing component and a quantum computing component. The classical computing component includes a non-transitory computer-readable memory that is configured to store program instructions and a processor coupled to the non-transitory computer-readable memory. The processor is configured to execute the program instructions that, when executed by the processor, cause the classical computing component to obtain initial parameters to an optimization problem stored in the non-transitory computer-readable memory of the classical computing component; create an objective function to the optimization problem based on the initial parameters; compute, based on the objective function and the initial parameters, encoded data to apply to a plurality of qubits in a quantum computing component; and implement a post-selection procedure to the optimization problem using the initial parameters and raw measurements to obtain an optimized solution to the optimization problem. The quantum computing component includes a plurality of qubits; and a controller coupled to the plurality of qubits. Further, the controller is configured to apply the encoded data to an initial state of the plurality of qubits to produce an updated state of the plurality of qubits; and provide the raw measurements of the updated state to the classical computing component.

In yet another example of the present disclosure, a tangible and non-transitory machine readable medium comprising instructions that when executed by a processor cause a hybrid quantum-classical computer to obtain, by a classical computing component of the hybrid quantum-classical computer, initial parameters to an optimization problem stored in memory of the classical computing component; create, by the classical computing component and based on the initial parameters, an objective function to the optimization problem; compute, by the classical computing component and based on the objective function and the initial parameters, encoded data; apply, by a quantum computing component of the hybrid quantum-classical computer, the encoded data to an initial state of a plurality of qubits to produce an updated state of the plurality of qubits; receive, the classical computing component, raw measurements of an updated state of the plurality of qubits; and implement, by the classical computing component and based on the initial parameters and the raw measurements, a post-selection procedure to the optimization problem to obtain an optimized solution to the optimization problem.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

Various aspects of this disclosure may be better understood upon reading the following detailed description and upon reference to the drawings in which:

FIG. 1 illustrates an embodiment of a computing system in accordance with principles described herein for performing operations as described herein;

FIG. 2 illustrates a flow chart of operations to carry out an algorithm that is performed on a hybrid computing system in accordance with principles described herein;

FIG. 3 illustrates a graphical representation of an example of analysis of input data used in conjunction with the algorithm of FIG. 2;

FIG. 4 illustrates a graphical representation of an example of input data to carry out the algorithm that is performed on a hybrid computing system of FIG. 1; and

FIG. 5 illustrates a graphical representation of an example of input data to carry out the algorithm that is performed on a hybrid computing system of FIG. 1.

### DETAILED DESCRIPTION OF EMBODIMENTS

The following discussion is directed to various exemplary aspects. However, one skilled in the art will understand that the examples disclosed herein have broad application, and that the discussion of any aspect is meant only to be exemplary of that aspect, and not intended to suggest that the scope of the disclosure, including the claims, is limited to that aspect.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . .” Use of the term “optionally” with respect to any element of a claim means that the element is required, or alternatively, the element is not required, both alternatives being within the scope of the claim. Moreover, the indefinite articles “a” or “an”, as used in the claims, are defined herein to mean one or more than one of the element that it introduces.

As used herein, the term “about”, “approximately”, or “substantially” when referring to a measurable value such as a parameter, an amount, a temporal duration, and the like, is meant to encompass variations of plus or minus (+/−)10% or less, preferably +/−5% or less, more preferably +/−1% or less, and still more preferably +/−0.1% or less of and from the specified value, or within one standard deviation of a mean, insofar such variations are appropriate to perform the disclosed embodiments.

Unless the context dictates the contrary, all ranges set forth herein should be interpreted as being inclusive of their endpoints, and open-ended ranges should be interpreted to include only commercially practical values. In addition, with respect to all ranges disclosed herein, such ranges are intended to include any combination of the mentioned upper and lower limits even if the particular combination is not specifically listed. All lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

The use of EVs has grown exponentially year-on-year and, consequently, the EV infrastructure has grown in order meet the energy needs of these EVs. Identifying an optimal location for EV charging stations for a geographical area is important for a growing EV vehicle pool in order to meet the needs of EV owners and EV infrastructure providers. However, selecting a network of sites for EV charging stations for, in some examples, increasing revenue to an infrastructure provider while increasing the demand for the EV charging station requires solving a spatial optimization problem for supporting the growing EV infrastructure is complex. The site of an EV charging station in a geographical area must not negatively impact revenues of other EV charging stations that are in proximity to the EV charging station. For instance, when an EV charging station is built too close to another EV charging station, the revenues of one or both of EV charging stations can be negatively impacted as much as up to 50 percent (%). Therefore, selecting an optimal location of EV charging stations in a geographical area that includes geometric constraints is a complex spatial global optimization problem that requires consideration of consider user density, traffic patterns, and costs associated with an EV charging station.

Conventionally, optimization methods may use variables and constraints in an objective/cost function to define an optimization problem. The optimization problem may be defined by an objective function that is to be minimized or maximized in order to select EV charging stations from a large number of sites of candidate EV charging stations (also referred to as “candidate sites”). In an example, EV charging stations may be located anywhere an existing gas station is located, or other highly populated areas. A site for installing an EV charging station may have to consider several location/sites within a large-scale layout of a geographical area with complex geographical data. Conventional optimization methods fall short when there are a large number of sites for candidate EV charging stations with many constraints and variables that are to be considered, which results in a complex combinatorial optimization problem. Physical modelling and optimization of EV charging stations requires exponential computation time as the complexity of the optimization problem increases with an increasing number of sites, variables, and constraints. In one example, a brute-force algorithm (also referred to as a brute-force search) may be applied to an optimization problem of optimizing the selection of EV charging stations by examining all possible candidate sites in a geographical area for identifying a subset of selected EV stations in the geographical area. However, the implementation costs of the brute-force algorithm is proportional to the number of sites of potential candidate EV charging stations. For example, selecting two sites for EV charging stations among five sites may require 25 computational steps. As more sites are evaluated (for example, 100 or more) for providing an optimal number of EV charging stations, the computational steps and, correspondingly, the implementation costs increase exponentially.

The present disclosure generally discusses implementation of an adiabatic quantum algorithm for solving an optimization problem of selecting a set of EV charging stations from a large number of candidate EV charging stations in a geographical area. In an embodiment, the optimization problem optimizes an objective function of selecting the set of EV charging stations by implementing a technique of an adiabatic quantum algorithm. In an example, the optimization problem is solved by minimizing an objective cost function or maximizing an objective profit function. In embodiments, present techniques allow for improvements to an optimization problem of identifying the set of EV charging stations that satisfies the objective function for a geographical area by using a combination of classical computing and quantum computing. In an example, the combination of classical computing and quantum computing increases the accuracy in obtaining a solution to the optimization problem (for example, obtaining a set of optimized sites of EV charging stations over conventional methods) and that maximizes accessibility and coverage of EV charging stations to users within a geographical area while maximizing profitability of the EV charging stations to an infrastructure provider.

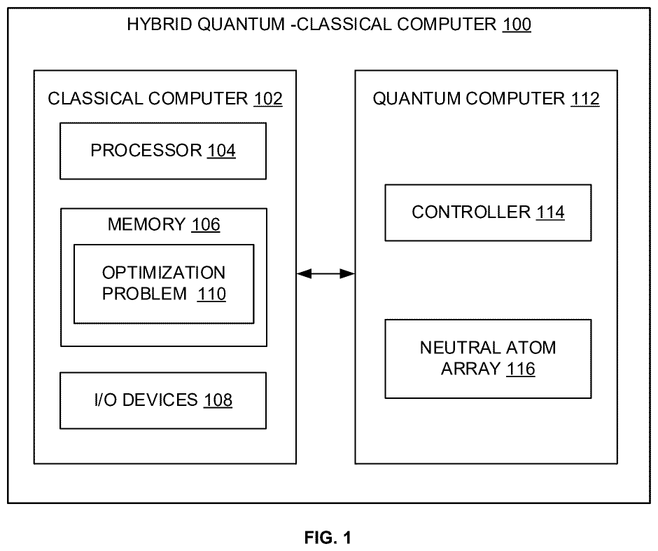

Referring now to FIG. 1, a block diagram of a hybrid quantum-classical computer system 100 for implementing the adiabatic quantum algorithm for solving an optimization problem is shown. In one embodiment, the optimization problem is to obtain a set of EV charging stations from a large number of possible sites of candidate EV charging stations in order to meet constraints and variables of a geographical area that defines an objective function for the optimization problem. The set of EV charging stations provides a solution to the optimization problem.

In this embodiment, hybrid quantum-classical computer system 100 includes a classical computing component and a quantum computing component. The classical computing component is classical computer system 102 (hereinafter, classical computer 102) and the quantum computing component is quantum computer system 112 (hereinafter quantum computer 112). Hybrid quantum-classical computer system 100 may execute instructions of an adiabatic quantum algorithm for solving optimization problem 110. In an example, the adiabatic quantum algorithm includes instructions that when executed may perform classical computation tasks (such as, for example, implementing simulated annealing or a Greedy algorithm) on classical computer 102, and may perform quantum computation tasks (such as, for example, quantum simulations or quantum annealing) on quantum computer 112 for solving optimization problem 110. In some implementations, hybrid quantum-classical computer 100 may perform quantum computation tasks on a quantum computer 112 by storing and manipulating information within qubits of neutral atoms in a neutral atom array 116 in order to solve optimization problem 110.

As previously described, hybrid quantum-classical computer system 100 includes classical computer 102 and quantum computer 112. Classical computer 100 includes processor 104 (which may be referred to as a central processor unit (CPU)) that is in communication with one or more memory devices 106, and input/output (I/O) devices 108. Processor 104 may be implemented as one or more CPU chips. Memory devices 106 may include secondary storage (e.g., one or more disk drives, etc.), a non-volatile memory device such as read-only memory (ROM), and a volatile memory device such as random-access memory (RAM). In some contexts, the secondary storage ROM, and/or RAM comprising memory devices 106 may be referred to as a tangible and non-transitory computer readable medium or a computer readable storage media. I/O devices 108 may include input and output device such as transceivers, buses, printers, video monitors, liquid crystal displays (LCDs), touch screen displays, keyboards, keypads, switches, dials, mice, and other well-known devices. Processor 104 reads bits from memory devices 106 and write bits to memory devices 106. For example, processor 104 may execute instructions of an adiabatic quantum algorithm from memory devices 106 for solving optimization problem 110, which may include instructions to coordinate with quantum computer 112 using I/O devices for implementing the adiabatic quantum algorithm. Classical computer 102 performs classical computations including data encoding, ansatz design, and simulated annealing while quantum computer 112 may perform quantum computing tasks such as quantum annealing based on an Ansatz on qubits of neutral atom array 116 at quantum computer 112. Processor 104 may receive results from neutral atom array 116 as measurement results based on quantum computing tasks performed at the quantum computer 112. In addition, processor 104 may perform post-processing on the measurement results using instructions to provide an output on I/O devices 108 that represents an optimized set of EV charging stations as a solution to optimization problem 110.

Computer programs comprising instructions for implementing algorithms (for example, the adiabatic quantum algorithm) may be implemented in a computer program product tangibly embodied in a machine-readable storage device for execution by processor 104, which may be either a classical processor or a quantum processor. Method steps of the of embodiments described herein may be performed by one or more computer processors executing a program tangibly embodied on a computer-readable medium to perform functions of adiabatic quantum algorithm by operating on inputs and generating outputs. Suitable processors include, byway of example, both general and special purpose microprocessors. Generally, the processor receives (reads) instructions and data from memory devices 106 (such as a ROM and/or a RAM) and writes (stores) instructions and data to the memory devices 106. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed application-specific integrated circuits (ASICs) or field programmable gate arrays (FPGAs). A classical computer 102 can generally also receive (read) programs and data from, and write (store) programs and data to, a tangible and non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

In this embodiment, quantum computer 112 includes controller 114 and neutral atom array 116. Neutral atom array 116 includes qubits (i.e., single Rubidium (Rb-87) neutral-atoms) that may be encoded and evolved using quantum annealing for implementing the adiabatic quantum algorithm that is realized on hybrid quantum-classical computer 100. Controller 114 (for example, a control circuit) may include any of a variety of circuitry and/or other machinery for performing the functions disclosed herein. Controller 114 may, for example, consist of classical hardware that is substantially similar to processor 104, and include memory devices 106 that store computer programs having instructions for execution by controller 114. In an example, controller 114 may generate and provide as output one or more control signals to qubits of neutral atom array 116. The control signals may take any of a variety of forms, such as any kind of electromagnetic signals, such as electrical signals, magnetic signals, optical signals (e.g., laser pulses), or any combination thereof. In some implementations, quantum computer 100 can operate as a quantum annealer that uses an adiabatic model for quantum computing. In an example, quantum annealing (QA) is a metaheuristic for finding the global minimum of a given objective function of the optimization problem 110 over a given set of candidate solutions (candidate locations or sites). In an example, neutral atom array 116 includes neutral atoms with qubits are initialized in an initial state, and the controlling Hamiltonian can be transformed adiabatically by adjusting control parameters to another state that can be measured to obtain an output of the quantum computation. Control signals may be delivered to the superconducting quantum integrated circuit, for example, to manipulate the quantum states of the neutral atom arrays, and information can be read from neutral atom array 116 by measuring the quantum states of neutral atom array 116 as measurement signals. Controller 114 may include a measurement circuit that may receive one or more feedback signal based on measurement signals received by measuring the final quantum states of qubits in neutral atom array 116. In an example, controller 114 may provide the measurement signals as measurement results to classical computer 102.

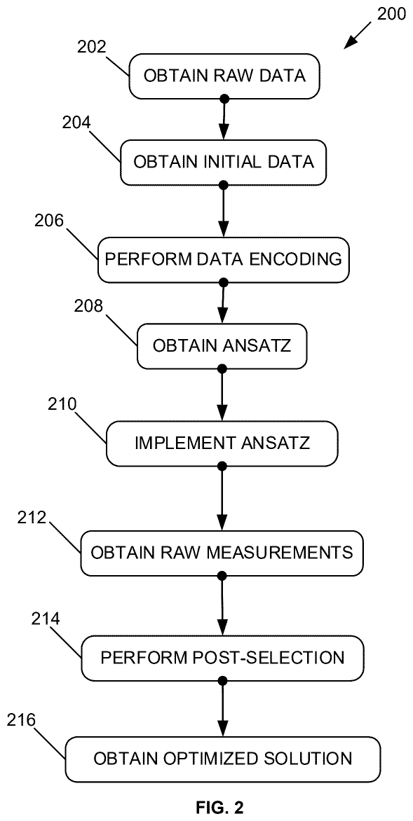

Referring now to FIG. 2, a flow chart of an embodiment of a method 200 that illustrates operations of an adiabatic quantum algorithm for optimizing selection of candidate EV charging stations is shown. Hybrid quantum-classical computer system 100 (FIG. 1) may implement method 200 including operations of an adiabatic quantum algorithm on for obtaining a solution set of EV charging stations that optimizes an optimization problem 110 (FIG. 1). Method 200 may provide a solution that maximizes a value of each location of a candidate EV charging station for selection from all candidate EV charging stations within a geographical area. Although method 200 is described in a particular order, it should be noted that method 200 may be performed in any suitable order.

At block 202, method 200 includes an operation of obtaining raw data of a geographical area for use by a user of hybrid quantum-classical computer system 100 in formulating an optimization problem such as, for example, optimization problem 110 in FIG. 1. Raw data are raw parameters applicable to a geographical area, constraints, and variables for identifying sites of candidate EV charging stations and may include, in examples, latitude and longitude of gas stations of an energy services provider, average income at the location, population density, zip code, traffic, and road information. The data may include addresses, states, longitude and latitude coordinates, crime index of an area/location, daytime population of an area, median household income of an area, average household income, total population, and population density.

At block 204, method 200 includes an operation of obtaining initial data from raw data for formulating an objective function. In an example, initial data are initial parameters of one or more components of the raw data that may be selected as decision variable and constraints in order to formulate the objective function for solving the optimization problem. Initial data represents the optimization problem and may include sites of gas stations within a geographical area that may be considered as sites of candidate EV charging stations, or other locations that may satisfy constraints that are to be met identifying locations for candidate EV charging stations. Identifying sites of candidate EV charging stations may include, in examples, data that includes latitude and longitude of gas stations of an energy services provider, average income at the location, population density, zip code, traffic, and road information. In embodiments, the initial data may include addresses, states, longitude and latitude coordinates, crime index of an area/location, daytime population of an area, median household income of an area, average household income, total population, and population density. Initial data may be stored in memory devices 106 (FIG. 1). In an embodiment, an objective function C(z) of z for optimization problem 110 may be defined as follows:

$$C ( z ) = {\sum }_{iϵz} {W}_{i} {n}_{i} - {\sum }_{i , jϵz} J ( {R}_{i j} ) {n}_{i} {n}_{j}$$

$$z = ( {n}_{0} , … , {n}_{N} )$$

$${n}_{i , j} ϵ \{ 0 , 1 \}$$

where z is a vector of sites of candidate EV charging stations (ni . . . nN) of the candidate EV charging stations, where n is an integer greater than zero, and ni and nj are binary values of 0 or 1 of sites i and j of candidate EV charging stations. If either of ni or nj is 0, a candidate EV charging station is not selected, and if either of ni or nj is 1, a candidate EV charging station is selected. N is a non-zero integer and represents a total number of candidate EV charging stations, and Wiis a reward that is applied to the objective function C(z) for a location of a candidate EV charging station. In an example, reward Wi may be a non-zero real number that is predetermined or precalculated based on a factor of a site of a candidate EV charging station. In general, a higher number represents an importance of a candidate EV charging station to the geographical area. Reward Wi may be predetermined from a median household income, or may be determined from a combination of household income, population, or population density, or a consideration of all potentially important factors for the site of the candidate EV charging station. Rij is an interaction penalty for distances between pairs of candidate EV charging stations that are less than, greater than, or equal to a threshold distance between pairs of candidate EV charging stations. In an example, the latitude and longitude coordinates at a site of a candidate EV charging station may be used to calculate the penalty. The interaction penalty Rij is added to the second term (for example, for site i and site J) to obtain a value of the site of the candidate EV charging station. When both ni and nj are 1, the interaction penalty Rij is added to a summation term of the objective function C(z), which minimizes the objective function. When a number of sites of candidate EV charging stations is large, for example, the number is 100 candidate sites, there are 2¹⁰⁰ possible choices of selecting an EV charging station. If there are 1000 sites for EV candidate charging stations, then the optimization is performed for 1000 iterations to obtain 2¹⁰⁰⁰ choices from the sites of candidate EV charging stations for a solution to the objective function.

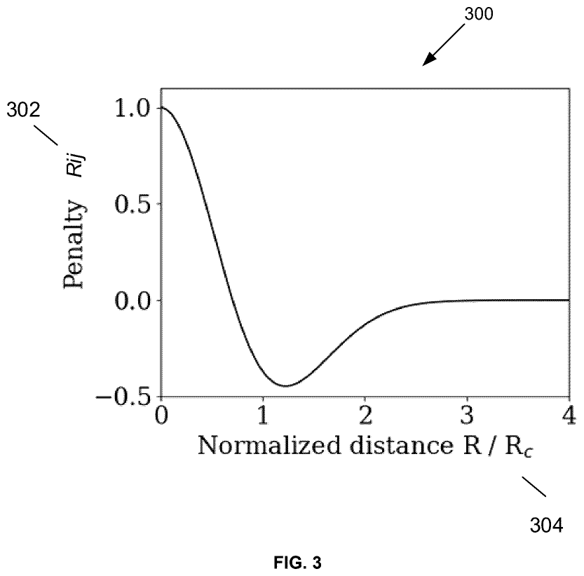

Referring now to FIG. 3, a graph 300 illustrating an interaction penalty for objective function C(z) is shown. As shown, the interaction penalty 302 (Rij) of the objective function C(z), may be a positive value, a zero-value, or a negative value. The longitude and latitude coordinates of a geographical location may be used to calculate a distance R between each pair of candidate EV charging stations. The distance R is normalized 304 with a specific distance (Rc). When the distance R between a pair of candidate EV charging stations is greater than a threshold distance, the candidate EV charging stations do not interact with each other (for instance, revenue or user demand is not affected based on the proximity of the pair of candidate EV charging stations), and the interaction penalty Rij 302 is zero. An optimized distance (Rc) between a pair of EV charging stations is a negative penalty, which is a reward. When sites of a pair of candidate EV charging stations are close to each other, a penalty is assigned to the objective function C(z) as the interaction between the two candidate EV charging stations negatively affects the value objective function, and minimizes the objective function C(z). In an example, maximizing the objective function C(z) may include adding a difference between a summation of rewards associated with distances between any two candidate EV charging stations for all candidate EV charging stations, and a summation of a penalty for candidate EV charging station that is too close to another EV charging station within the geographical area.

Returning to FIG. 2, method 200 includes an operation of performing data encoding at block 206. Data encoding may be performed by classical computer 102 (FIG. 1). Data encoding may include identifying a geometric configuration of an array of neutral atoms that corresponds to a lattice-spacing optical lattice comprising vertices, and obtaining a detuning potential Δ(t) for each vertex. Data encoding may include the detuning potential Δ(t) that corresponds to the reward Wᵢ of the first summation term in the objective function C(z) of each atom in the array (for example, ΣWᵢnᵢ). The detuning potential Δ(t) may represent a bias for sites that are more likely to be selected (for example, sites that are more likely to be in a ground state |0)), and which is controlled during quantum annealing at quantum computer 112. Each atom is located at a vertex of the lattice, and the vertices represent sites of candidate EV charging stations in a real-world analogue.

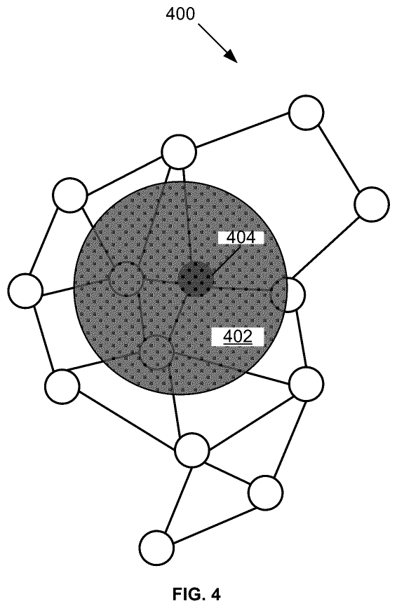

Referring now to FIG. 4, a graph 400 that illustrates an example of encoded data with an array of vertices representing neutral atoms in a unit disk graph 402 of unit radius, with a single vertex 404 being connected to all other vertices is shown. The optimization problem is encoded with neutral atoms placed at the vertices of a target graph that represent sites of candidate EV charging stations, and with interatomic spacing between the vertices chosen such that the unit disk radius of the unit disk graph 402 is linked to the Rydberg blockade radius of the neutral atoms of the atom array of quantum computer 112, and the detuning potential Δ(t) of the vertices. The neutral atom array may be weighted by the detuning potential Δ(t). The detuning potential corresponds to the reward Wᵢ of the first summation term in the objective function C(z) of each atom in the array (for example, ΣWᵢ nᵢ). The encoded data may include a time series of the Rabi drive amplitude Ω(t), detuning potential Δ(t), phase φ(t), and position of each atom {x^{→}}. The Rabi drive amplitude Ω(t) sets the frequency at which each qubit oscillates between ground and Rydberg states in the absence of interaction (for example, a transition rate between ground state |0) and Rydberg state |r)), the detuning potential Δ(t) may set how off resonant the global Rabi drive is, the phase φ(t) of the Rabi drive sets the direction around which the qubit is driven in the X or Y direction, and the position {x^{→}} is of each atom in the 2D array and sets the Rydberg-Rydberg interaction strength between each qubit. The logical 0 state is associated with the ground state |0)=\g), and the logical 1 state is associated with the excited Rydberg state |1)=|r).

At block 208, method 200 includes an operation of obtaining an Ansatz for a quantum computing system. In an example, the Ansatz provides an initial estimate of the solution to the computational problem. Classical computing system 102 generates an initial time-dependent Hamiltonian and a final (or target) time-dependent Hamiltonian for the array based on the computational problem to be solved, a rate for the adiabatic process (annealing rate), and length of time evolution as an annealing schedule as an Ansatz. A Schrödinger equation may be used to describe a transformation of the system with time from the initial Hamiltonian to the target Hamiltonian. Changes in the state of a system may be related to the energy in the system (given by the initial Hamiltonian). The initial Schrödinger equation may obtain the time-dependent evolution from the initial Hamiltonian to the target Hamiltonian as a function of time. The initial Hamiltonian at time T=T₀ corresponds to a ground state with atoms either at energy levels 0 or 1. Hamiltonian parameters are slowly ramped from the initial Hamiltonian to a target Hamiltonian over time T=T_{Final}. If slow enough under the adiabatic condition, an initial state that is the ground state of the initial Hamiltonian evolves to become the ground state of the target Hamiltonian. If such a process is slow enough, the quantum state of the system stays close to the ground state of the time-dependent Hamiltonian at time T_{Final}. At the end of the time evolution, the set of neutral atoms is determined to be in a final state, which is expected to be close to the ground state |0), and implements a quantum evolution and corresponds to the solution to the optimization problem. A Schrödinger equation may be used to describe how a system changes with time from the initial Hamiltonian in order to obtain the target Hamiltonian. It does this by relating changes in the state of the system to the energy in the system (given by the initial Hamiltonian). The initial Schrödinger equation may obtain the time-dependent evolution from the initial Hamiltonian to the target Hamiltonian as a function of time.

At block 210, method 200 includes an operation of implementing the Ansatz on quantum computer 112. The encoded data is applied to an initial state of the plurality of qubits to produce an updated state as the Ansatz is implemented. The quantum computer 112 starts in an initial state and ramps up from some initial Hamiltonian to a target Hamiltonian. The quantum computer 112 prepares a well-known initial state of the neutral atom array 116 (FIG. 1) using the encoded data and the initial Hamiltonian. The initial state of two atoms in the atoms array is initialized in the ground state with the initial Hamiltonian, and evolves its quantum state (for example, undergoes quantum evolution) according to an annealing schedule, and terminates at the final Hamiltonian. If the rate of change of the system Hamiltonian is slow enough, the system stays close to the ground state of the instantaneous Hamiltonian. At the end of the time evolution, the set of qubits on the quantum annealer is in a final state, which is expected to be close to the ground state and corresponds to the solution to optimization problem. The quantum computer 112 places atoms at positions defined by the vertices of the array, initializes them to the ground state |0) and implements a coherent quantum evolution under a programmable laser drive based on Rabi drive rate Ω(t), detuning potential Δ(t), and phase φ(t) for each atom to obtain a final quantum ground state. The final state of the quantum computer 112 is measured after each iteration to obtain a number of qubits in the ground state of the set of neutral atom arrays. The interaction potential of neutral atoms in the neutral atom array is controlled by the detuning potential, which maximizes the total number of qubits in the Rydberg state under the blockade constraint. The Ansatz is implemented for a predetermined number of iterations (for example, 1000 iterations), and the final state is measured after each iteration.

At block 212, method 200 includes an operation of obtaining raw measurements from the quantum computer 112. In some embodiments, quantum computer 112 may apply a transformation to an initial state of qubits to obtain a final state after quantum evolution. The final state of the quantum computer 112 is measured after each iteration of the objective function to produce measurement results (for example, raw data). The raw measurements are obtained for each iteration of the Ansatz (for example, 1000 iterations) until the output size of qubits in the ground states is a significant percentage. The solution to the optimization problem is an approximate solution and includes a solution with Rydberg states of atoms in the atom array that correspond to the selected sites of candidate EV charging stations.

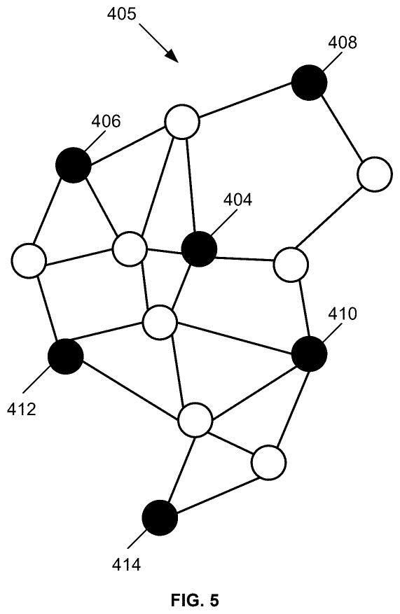

FIG. 5 is a graph 405 that illustrates an example of an output of quantum computer 112 with an array of excited atoms that represents a solution to the optimization problem that is obtained from the array of vertices representing neutral atoms as shown in FIG. 4. The solution to the optimization problem defines a set of sites of EV charging stations corresponding to Rydberg states of neutral atoms in the neutral atom array. In an example, vertices 404-414 in graph 405 represent a raw result of sites of EV charging stations corresponding to a solution set that is based on Rydberg atom arrays. The solution set may be a maximum independent set that is based on a Rydberg blockade mechanism that restricts evolution to a subspace spanned by the states that obey the independent set constraint of graph 405.

At block 214, method 200 includes an operation of performing a post-selection procedure on the approximate solution of the raw measurements of the output of quantum computer 112. To improve the final measurements, a classical post-processing procedure is used. The raw measurements are implemented on a classical optimizer to initialize a state of the optimizer, after which the classical optimizer is run on the objective function to obtain a refined optimized solution or result to the optimization problem as a final measurement. A greedy algorithm is run minimally to remove independent set violations by finding a greedy independent set on a subgraph induced by the Rydberg measurements. Then, the greedy algorithm is implemented to add vertices to the independent set to find an independent set as an optimized solution to the optimization problem. Simulated annealing may be used as an alternative classical optimizer. For instance, simulated annealing may minimize the energy of the final Hamiltonian while maintaining thermal equilibrium. In other embodiments, other classical optimizers that are similar to the Greedy algorithm or simulated annealing such as, for example, a GUROBI optimizer may be implemented.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Each and every claim is incorporated into the specification as an aspect of the present disclosure. Thus, the claims are a further description and are an addition to the aspects of the present disclosure. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein. In the event of conflict, the present specification, including definitions, is intended to control.

What is claimed is:

1. A method, comprising:
obtaining, by a classical computing component, initial parameters to an optimization problem and that is stored in memory of the classical computing component;
creating, by the classical computing component based on the initial parameters, an objective function to the optimization problem;
computing, by the classical computing component and based on the objective function and the initial parameters, encoded data;
applying, by a quantum computing component, the encoded data to an initial state of a plurality of qubits to produce an updated state of the plurality of qubits;
providing, by the quantum computing component, raw measurements of the updated state to the classical computing component; and
implementing, by the classical computing component and based on the initial parameters and the raw measurements, a post-selection procedure to the optimization problem to obtain an optimized solution to the optimization problem.

2. The method of claim 1, further comprising obtaining an Ansatz on the plurality of qubits as an estimated solution to the optimization problem.

3. The method of claim 1, wherein computing the encoded data comprises obtaining a detuning potential for a geometric configuration of atoms in an atom array of the quantum computing component.

4. The method of claim 1, wherein obtaining the initial parameters to the optimization problem comprises obtaining initial data corresponding to a plurality of sites of candidate electric vehicle (EV) charging stations within a geographical area, and wherein the initial data represents the optimization problem.

5. The method of claim 4, wherein the objective function comprises a difference between a first summation and a second summation, wherein the first summation comprises a reward for each site of the plurality of sites, and wherein the second summation comprises an interaction penalty for pairs of the plurality of sites.

6. The method of claim 1, wherein computing the encoded data comprises:
identifying a geometric configuration of an array of neutral atoms at vertices of the array, wherein each neutral atom of the array represents a site of a plurality of sites of candidate electric vehicle (EV) charging stations within a geographical area; and
obtaining a detuning potential for each neutral atom of the array.

7. The method of claim 6, wherein the detuning potential is based on a reward for each site of the plurality of sites of candidate EV charging stations.

8. The method of claim 1, further comprising obtaining the raw measurements based on the initial state and a time-dependent evolution of the initial state to a final state of the plurality of qubits.

9. A hybrid quantum-classical computer, comprising:
a classical computing component comprising:
a non-transitory computer-readable memory storing program instructions; and
a processor coupled to the non-transitory computer-readable memory and configured to execute the program instructions to cause the classical computing component to:
obtain initial parameters to an optimization problem stored in the non-transitory computer-readable memory of the classical computing component;
create, based on the initial parameters, an objective function to the optimization problem;
compute, based on the objective function and the initial parameters, encoded data to apply to a plurality of qubits in a quantum computing component; and
implement, based on the initial parameters and raw measurements, a post-selection procedure to the optimization problem to obtain an optimized solution to the optimization problem; and
a quantum computing component comprising:
a plurality of qubits; and
a controller coupled to the plurality of qubits and configured to:
apply the encoded data to an initial state of the plurality of qubits to produce an updated state of the plurality of qubits; and
provide the raw measurements of the updated state to the classical computing component.

10. The hybrid quantum-classical computer of claim 9, wherein the program instructions that when executed by the processor further cause the classical computing component to obtain an Ansatz on the plurality of qubits as an estimated solution to the optimization problem.

11. The hybrid quantum-classical computer of claim 9, wherein when computing the encoded data the program instructions that when executed by the processor cause the classical computing component to obtain a detuning potential for a geometric configuration of atoms in an atom array of the quantum computing component.

12. The hybrid quantum-classical computer of claim 9, wherein when obtaining the initial parameters to the optimization problem the program instructions that when executed by the processor cause the classical computing component to obtain initial data corresponding to a plurality of sites of candidate electric vehicle (EV) charging stations within a geographical area, and wherein the initial data represents the optimization problem.

13. The hybrid quantum-classical computer of claim 12, wherein the objective function comprises a difference between a first summation and a second summation, wherein the first summation comprises a reward for each site of the plurality of sites, and wherein the second summation comprises an interaction penalty for pairs of the plurality of sites.

14. The hybrid quantum-classical computer of claim 9, wherein when computing the encoded data the program instructions that when executed by the processor cause the classical computing component to:
identify a geometric configuration of an array of neutral atoms at vertices of the array, wherein each neutral atom of the array represents a site of a plurality of sites of candidate electric vehicle (EV) charging stations within a geographical area; and
obtain a detuning potential for each neutral atom of the array.

15. The hybrid quantum-classical computer of claim 14, wherein the detuning potential is based on a reward for each site of the plurality of sites.

16. The hybrid quantum-classical computer of claim 9, wherein the controller if further configured to obtain the raw measurements based on the initial state of the plurality of qubits and a time-dependent evolution of the initial state to a final state of the plurality of qubits.

17. A tangible and non-transitory machine readable medium comprising instructions that when executed by a processor cause a hybrid quantum-classical computer to:
obtain, by a classical computing component of the hybrid quantum-classical computer, initial parameters to an optimization problem stored in memory of the classical computing component;
create, by the classical computing component and based on the initial parameters, an objective function to the optimization problem;
compute, by the classical computing component and based on the objective function and the initial parameters, encoded data;
apply, by a quantum computing component of the hybrid quantum-classical computer, the state of a plurality of qubits to produce an updated state of the plurality of qubits;
receive, the classical computing component, raw measurements of the updated state; and
implement, by the classical computing component and based on the initial parameters and the raw measurements, a post-selection procedure to the optimization problem to obtain an optimized solution to the optimization problem.

18. The tangible and non-transitory machine readable medium of claim 17, wherein the quantum computing component comprises an array of neutral atoms, and wherein computing the encoded data further comprises instructions that when executed by the processor cause the hybrid quantum-classical computer to obtain, a detuning potential for a geometric configuration of the plurality of qubits in the array.

19. The tangible and non-transitory machine readable medium of claim 18, wherein the detuning potential is based on a reward for each site of a plurality of sites of candidate electric vehicle (EV) charging stations.

20. The tangible and non-transitory machine readable medium of claim 17, wherein the quantum computing component comprises an array of neutral atoms, and wherein when computing the encoded data the instructions that when executed by the processor further cause the hybrid quantum-classical computer to:
identify a geometric configuration of the array at vertices of the array, wherein each neutral atom of the array represents a site of a plurality of sites of candidate electric vehicle (EV) charging stations within a geographical area; and
obtain a detuning potential for each neutral atom of the array.
